(19) United States
(12) Patent Application Publication
(10) Pub. No.: US 2015/0292465 A1
(43) Pub. Date: Oct. 15, 2015

(54) VEHICLE STARTER ACTIVATION COUNTER

(71) Applicant: FORD GLOBAL TECHNOLOGIES, LLC, Dearborn, MI (US)

(72) Inventors: Robert Wright, Royal Oak, MI (US); Marvin Paul Kraska, Dearborn, MI (US)

(21) Appl. No.: 14/251,783

(22) Filed: Apr. 14, 2014

(51) Int. Cl. F02N 11/08; B60W 20/00

(52) U.S. Cl. CPC F02N 11/0848; B60W 20/00; Y10S 903/905

(57) ABSTRACT

An example method includes initiating an alert in response to a starter activating for a number of cycles. An example device includes a counter that counts cycles of a starter. The starter is configured to activate multiple times during a single drive cycle to start an internal combustion engine. A controller initiates an alert in response to one or more of the cycles. A display is included to display the alert.

### BACKGROUND

This disclosure relates generally to counting starter activations in an electrified vehicle, start stop vehicle, hybrid, or plug in hybrid vehicle.

Example vehicles include hybrid electric vehicles (HEVs), and plug-in hybrid electric vehicles (PHEVs). Generally, hybrid vehicles differ from conventional motor vehicles because hybrid vehicles are selectively driven using a battery-powered electric machine. Conventional motor vehicles, by contrast, rely exclusively on an internal combustion engine to drive the vehicle. The internal combustion engine of a conventional motor vehicle starts and stops a once during a drive cycle.

During a single drive cycle, the internal combustion engine of hybrid or start stop vehicle may start and stop several times. Several devices exist for restarting the engine. These include 12-volt starter motors, 48-volt starter motors, and electric machines. Each device has unique limitations with respect to cost, durability, etc. Over the life of a vehicle, the number of engine shut down and restart events will far exceed the number of starts permitted by a conventional starter due to durability constraints.

### SUMMARY

A method according an exemplary aspect of the present disclosure includes, among other things, starting an internal combustion engine multiple times during a single drive cycle, and initiating an alert in response to a vehicle starter activating for a number of cycles.

In another example of the foregoing method, the cycles each comprise a start activation of the vehicle starter.

In another example of any of the foregoing methods, the method comprises replacing the vehicle starter in response to the number of cycles exceeding a threshold value.

In another example of any of the foregoing methods, the threshold value is a number of cycles corresponding to a projected end-of-life.

In another example of any of the foregoing methods, the method includes starting an internal combustion engine using the vehicle starter.

In another example of any of the foregoing methods, the method includes powering a vehicle using the internal combustion engine.

In another example of any of the foregoing methods, the vehicle comprises a modular hybrid transmission.

In another example of any of the foregoing methods, the method comprises starting an internal combustion engine using the vehicle starter when the number of cycles is equal to or less than a threshold value, and starting the internal combustion engine using an electric machine when the number of cycles exceeds the threshold value.

In another example of any of the foregoing methods, the alert comprises a message to a driver of the vehicle.

In another example of any of the foregoing methods, the method includes initiating a first alert when the number of cycles are within the first range, and initiating a second, different alert when the number of cycles is outside the first range.

In another example of any of the foregoing methods, the method includes powering the vehicle starter with a 12-volt battery.

A device according to another exemplary aspect of the present disclosure includes, among other things, a controller that initiates an alert in response to a starter activating for a number of cycles. The starter is configured to activate multiple times during a single drive cycle to start an internal combustion engine A counter that counts the number of cycles. A display to display the alert.

In another example of the foregoing device, the cycles each comprise a start activation of the vehicle starter.

In another example of any of the foregoing devices, an internal combustion engine starts when an vehicle starter cycles.

In another example of any of the foregoing devices, an internal combustion engine powers an vehicle.

In another example of any of the foregoing devices, the internal combustion engine powers a modular hybrid transmission.

In another example of any of the foregoing devices, the display comprises a passenger compartment display.

In another example of any of the foregoing devices, the display displays a first alert when a number of cycles are within a first range and displays a second, different alert when the number of cycles exceed the first range.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DESCRIPTION OF THE FIGURES

The various features and advantages of the disclosed examples will become apparent to those skilled in the art from the detailed description. The figures that accompany the detailed description can be briefly described as follows:

FIG. 1 shows a schematic view of an example modular hybrid transmission.

FIG. 2 shows a highly schematic view of an example device utilized in connection with the modular hybrid transmission of FIG. 1.

FIG. 3 shows an example method performed by the device of FIG. 2.

### DETAILED DESCRIPTION

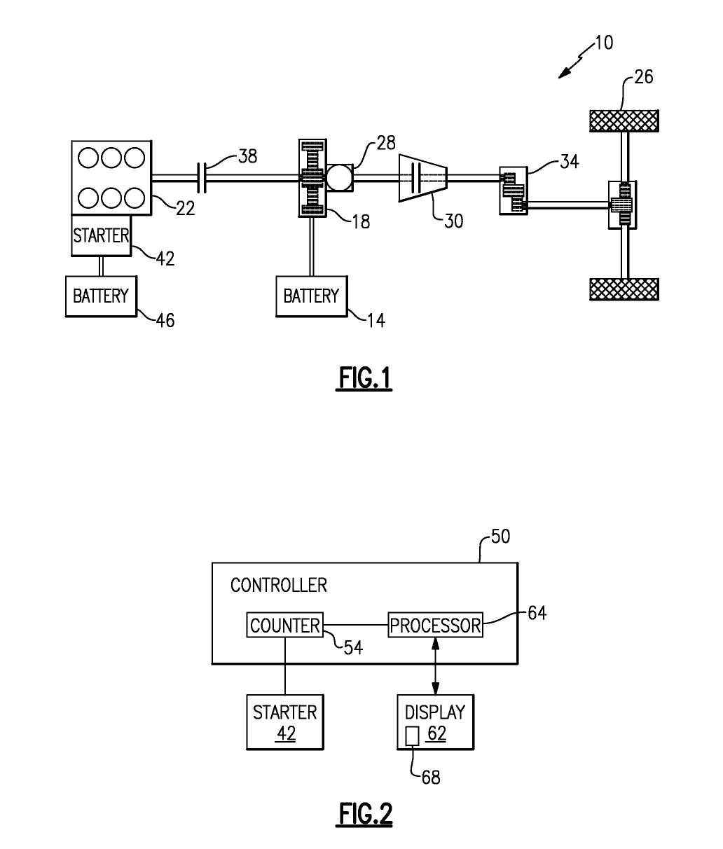

Referring to FIG. 1, an example modular hybrid transmission 10 for a vehicle includes a high voltage battery 14, an electric machine 18 and an internal combustion engine 22. The example transmission 10 is incorporated into hybrid electric vehicle (HEV). It should be understood, however, that the concepts described herein are not limited to HEVs and could extend to other unconventional vehicles including, but not limited to, plug-in hybrid electric vehicles (PHEVs), diesel vehicles, start-stop vehicles, etc.

Unconventional vehicles are, generally, vehicles configured to start and stop an internal combustion engine more than one time during a single drive cycle. Start-stop vehicles are a mild hybrid and a type of unconventional vehicle. Start-stop vehicles may stop and restart an internal combustion engine during a drive cycle, at a stoplight for example, to reduce the amount of time the engine spends idling. Start-stop vehicles may or may not include an electric vehicle powertrain. Conventional vehicles, by contrast, start the engine at a beginning of a drive cycle, and stop the vehicle at the end of a drive cycle.

In an example embodiment of an unconventional vehicle, the vehicle employs a first drive system and a second drive system. The first drive system includes a combination of at least the electric machine 18 and the high voltage battery 14. In this example, the first drive system is considered an electric drive system of the transmission 10. The second drive system includes a combination of the internal combustion engine 22 and the electric machine 18.

The first and second drive systems generate torque to drive one or more sets of vehicle drive wheels 26 through a transmission pump 28, a launch clutch or torque converter 30, and a transmission gearbox 34.

When the first drive system is employed, a disconnect clutch 38 may operably disconnect the internal combustion engine 22 from the remaining portions of the transmission 10. When the second drive system is employed, the disconnect clutch 38 engages, and the internal combustion engine 22 is activated and cranked. The internal combustion engine 22 is then able to drive the drive wheels 26.

The disconnect clutch 38 can remain engaged when the first or second drive system is employed. This engagement allows the internal combustion engine 22 to drive the electric machine 18 to charge the high voltage battery 14.

The electric machine 18 is a combined motor-generator in this example. In other examples, the electric machine 18 includes a motor and a separate generator.

The electric machine 18 can be used to start the internal combustion engine 22 through the clutch 38. The electric machine 18 may periodically be unavailable to start the internal combustion engine 22 due to the clutch 38 being disconnected, for example, for the high voltage battery 14 being significantly drained.

In some examples, the clutch 38 is engaged and starting the internal combustion engine 22 using the electric machine 18 is possible

Instead of the electric machine 18, a starter 42 may be used to start the internal combustion engine 22. A relatively low voltage battery 46, such as a 12-volt battery, powers the example starter 42. In this example, the starter 42 is a conventional starter appropriate for use within a conventional motor vehicle driven by an internal combustion engine.

In some start-stop vehicles, there is no electric machine and the starter 42 is always relied on to start the internal combustion engine 22.

The transmission 10 may alternate between the first and second drive systems several times in a single drive cycle. The internal combustion engine 22 thus may thus be started or activated several times during a single drive cycle.

The internal combustion engine 22 cycles more often during drive cycles than the internal combustion engines of conventional motor vehicles. The example transmission 10 may require an estimated 1,000,000 starts of the internal combustion engine 22 during its lifetime. Conventional motor vehicles do not demand more than 300,000 cycles from a starter.

The life expectancy of the starter 42 represents a minimum estimated number of starter cycles possible before the starter 42 may fail. The starter 42 is designed to have a certain life expectancy.

Since the starter 42 is of the type used in conventional motor vehicles, the starter 42 has a life expectancy less than 1,000,000 cycles, such as a 300,000 cycles for example. Thus, when used in the hybrid transmission 10, the low voltage starter 42 may near an end of life prior to remaining components.

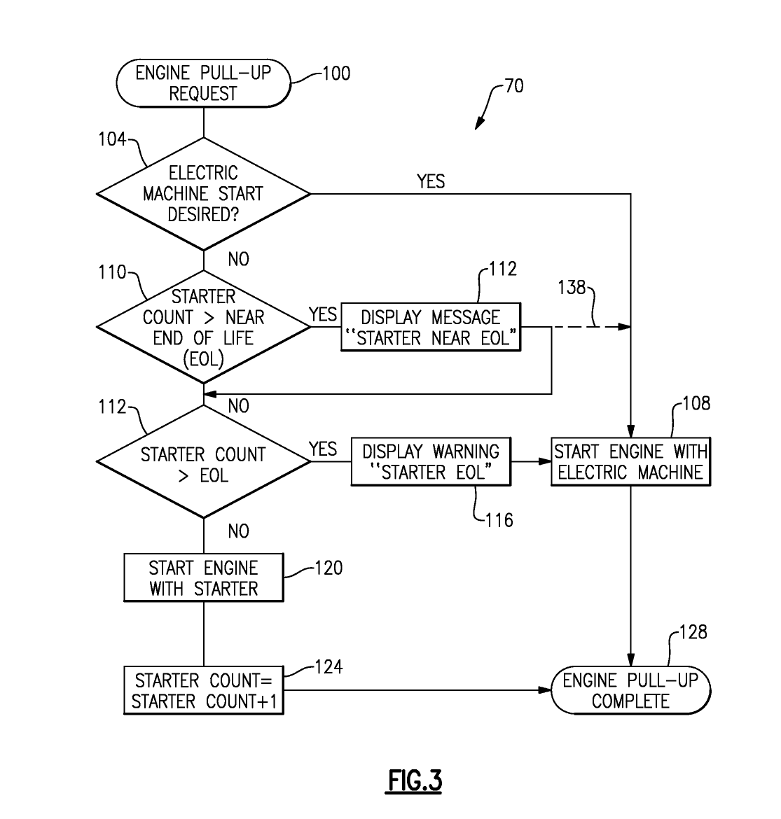

Referring now to FIG. 2 with continued reference to FIG. 1, a controller 50 monitors cycles of the example starter 42. The monitoring helps determine when the starter 42 needs to be replaced, for example. Replacing the starter 42 before exceeding 300,000 cycles ensures that the starter 42 will not reach its end of life within the transmission 10.

The example controller 50 includes a counter 54 and a processor 64. The controller 50 is coupled to a display 62 and the starter 42. The controller 50, in this example, is a type of device and forms a portion of an engine controller.

The counter 54 counts the cycles of the starter 42 and maintains a running total count of the cycles. The counter 54, in one example, is stored within a random access memory portion of the controller 50.

In this example, each cycle of the starter 42 increments the running total count by one in this example. In another example, the counter 54 adjusts the running total count differently according to the conditions associated with the cycle. A cycle at temperatures below freezing, for example, may cause the counter 54 to increase the running total count by two instead of one. In these examples, the counter 54 weights a cycle differently according to environmental factors, like temperature, or other factors that could influence how much a cycle wears the starter 42.

The example counter 54 may count start activations of the starter 42, or some other component, to determine whether the starter 42 has activated.

The processor 64 is configured to execute a program stored in a memory portion of the controller 50. Executing the program causes the controller 50 to display an alert 68 on the display 62 in response to the running total count counted by the counter 54.

The display 62, in this example, is part of a human-machine interface portion of the electric vehicle having the transmission 10. The example alert 68 is a text-based message on the display 62, such as a message stating “STARTER APPROACHING END OF LIFE,” “STARTER EXCEEDING END OF LIFE,” or “REPLACE STARTER SOON.”

The display 62 may be within an instrument panel and viewable by the driver, for example. The alert or warning could also prompt a driver to pull an error code.

Referring now to FIG. 3 with continued reference to FIGS. 1 and 2, an example program executed by the processor 64 may follow generally the flow of a method 70 shown in FIG. 3.

At a step 100, the method receives a request to pull-up the internal combustion engine 22. At a step 104, the method 70 first determines if the electric machine 18 should be used to start the internal combustion engine 22. If so, the method 70 proceeds to a step 108 where the electric machine 18 starts the internal combustion engine 22.

If at the step 104, the electric machine 18 is unable to start the internal combustion engine 22 due to, for example, low power level within the high voltage battery 14, the method 70 moves to a step 110.

Under some driving conditions, it may be desirable to start the engine 22 using the starter 42 rather than electric machine 18, even though the electric machine 18 is capable of starting the engine 22. Starting the engine 22 using the starter 42 rather than the electric machine 18 may provide drivability advantages, for example. The method 70 may move to the step 110 from step 104 under these driving conditions.

At the step 110, the method 70 checks the running total count of starter 42 cycles counted by the counter 54. If the running total count exceeds a first threshold value indicating the starter 42 is near an end of useable life, 250,000 cycles, for example, the method 70 proceeds to a step 112 where the display 62 displays the alert 68 indicating that the starter 42 is near an end of life.

The method 70 then proceeds to a step 112, which determines if the running total count of cycles of the starter 42 exceeds a second threshold value indicating the starter 42 has exceeded its usable life. If the count does exceed the second threshold value at step 112, the method 70 proceeds to a step 116 where the display 62 changes the alert 68 to indicate that the starter 42 is past the end of life.

If the running total count indicates that the starter 42 is past its end of life, the method proceeds from the step 116 to the step 108 to require starting the engine 22 utilizing the electric machine 18. This may require recharging the high voltage battery 14.

If, at the step 112, the running total count does not equal the threshold value, the starter 42 activates to pull-up the engine 22 at a step 120. The counter 54 adds to the running total count in response to activating the starter 42.

From both the steps 108 and 124, the method proceeds to a step 128 where the pull-up of the engine 22 is completed. At this step, the example engine 22 moves from crank speed to a self-sustaining rotational.

In some examples, the method 70 at the step 112 may follow alternative path 134 start the engine 22 with the electric machine 18 rather than the starter 42. The method 70 thus allocates starts to the electric machine 18 when the running total count exceeds the first threshold value.

In such examples, when the running total count is at or below the first threshold value, starting the engine 22 with the starter 42 is prioritized ahead of starting the engine 22 with the electric machine 18. When the running total count is above the first threshold value, but at or below the second threshold value, starting the engine 22 with the electric machine 18 is prioritized ahead of staring the engine 22 with the starter 42. When the running total count is above the second threshold value, starting the engine 22 with the electric machine 18 is required.

Thus, as the starter 42 approaches its end of life, the demands on the starter 42 are reduced. To reduce demand, the controller 50 directs more and more starts to the electric machine 18.

Fleet customers, in particular those with their own service department, often desire vehicles having optimized fuel efficiency to save on fuel expenditures. Such customers, in particular, would benefit from knowing that service should be scheduled soon in advance of starter failure

In some prior art examples, due to the durability constraints of the starting system, the engine is not commanded to shut off because the number of starts is trying to be rationed over the life of the vehicle. This rationing reduces fuel economy by not shutting down the engine in modes that would have been optimal to do so from a fuel efficiency basis.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A method, comprising:
starting an internal combustion engine multiple times during a single drive cycle; and
initiating an alert in response to a starter activating for a number of cycles.

2. The method of claim 1, wherein the cycles each comprise a start activation of the starter.

3. The method of claim 1, further comprising replacing the starter in response to the number of the cycles exceeding a threshold value.

4. The method of claim 3, wherein the threshold value is the number of cycles corresponding to a projected end-of-life.

5. The method of claim 1, further comprising starting an internal combustion engine using the starter.

6. The method of claim 5, further comprising powering a vehicle using the internal combustion engine.

7. The method of claim 6, wherein the vehicle comprises a modular hybrid transmission vehicle.

8. The method of claim 1, further comprising starting an internal combustion engine using the starter when the number of cycles is equal to or less than a threshold value, and starting the internal combustion engine using an electric machine when the number of cycles exceeds the threshold value.

9. The method of claim 1, wherein the alert comprises a message to a driver of the vehicle.

10. The method of claim 1, further comprising initiating a first alert when the number of cycles are within a first range, and initiating a different, second alert when the number of the cycles is outside the first range.

11. The method of claim 10, including powering the starter with a 12 volt battery.

12. A device, comprising:
a controller that initiates an alert in response to a starter activating for a number of cycles, the starter configured to activate multiple times during a single drive cycle to start an internal combustion engine;
a counter that counts the number of cycles; and
a display to display the alert.

13. The device of claim 12, wherein the cycles each comprise a start activation of the starter.

14. The device of claim 12, further comprising an internal combustion engine that starts when the starter cycles.

15. The device of claim 14, wherein the internal combustion engine powers a vehicle.

16. The device of claim 14, wherein the internal combustion engine powers a modular hybrid transmission.

17. The device of claim 12, wherein the display comprises a passenger compartment display.

18. The device of claim 12, further comprising initiating a first alert when a number of the cycles are within a first range, and initiating a second alert when the number of the cycles exceeds the first range.

19. The device of claim 12, further comprising a low-voltage battery to power the starter.

20. The device of claim 19, wherein the low-voltage battery is a 12-volt battery.
